(19) United States
(12) Patent Application Publication
(10) Pub. No.: US 2025/0142262 A1
(43) Pub. Date: May 1, 2025

(54) LOUDSPEAKERS AND METHODS OF USE THEREOF

(71) Applicant: CLEAN ENERGY LABS, LLC, Austin, TX (US)

(72) Inventors: Joseph F. PINKERTON, Austin, TX (US); David A. BADGER, Lago Vista, TX (US)

(73) Assignee: BRANE AUDIO, LLC, Austin, TX (US)

(21) Appl. No.: 18/684,087

(22) PCT Filed: Aug. 26, 2022
(86) PCT No.: PCT/US22/41747

§ 371 Date: Feb. 15, 2024

Related U.S. Application Data
(60) Provisional application No. 63/339,760, filed on May 9, 2022.
(60) Provisional application No. 63/237,844, filed on Aug. 27, 2021.

(51) Int. Cl. H04R 11/14; H04R 9/02; H04R 9/04; H04R 9/06; H04R 11/02

(52) U.S. Cl. CPC H04R 11/14; H04R 9/025; H04R 9/046; H04R 9/063; H04R 11/02

(57) ABSTRACT

Electroacoustic drivers that can be utilized in loudspeaker systems that utilize drivers having a magnetic negative spring (MNS). A variable volume device, such as a bellow, is used to vary the enclosed air volume of the sealed chamber of the loudspeaker.

### RELATED PATENTS/PATENT APPLICATIONS

This application claims priority to (a) U.S. Patent Application Ser. No. 63/237,844, filed Aug. 27, 2021, to Joseph F. Pinkerton, entitled “Loudspeakers and Methods Of Use Thereof;” and (b) U.S. Patent Application Ser. No. 63/339,760, filed May 9, 2022, to Joseph F. Pinkerton, et al., entitled “Loudspeakers and Methods Of Use Thereof.” These patent applications are commonly owned by the owner of the present invention. These applications (including appendices) are hereby incorporated by reference in their entirety for all purposes.

This application is also related to International Patent Application No. PCT/US2020/051633, filed Sep. 18, 2020, to Joseph F. Pinkerton et al., entitled “Electroacoustic Drivers And Loudspeakers Containing Same,” (the “Pinkerton '633 PCT Application”). The Pinkerton '633 PCT Application is incorporated herein in its entirety for all purposes.

### TECHNICAL FIELD

The present invention relates to loudspeakers and methods of use thereof, and in particular loudspeakers having drivers including a magnetic negative spring (MNS) (such as reluctance assist drivers (RAD) and permanent magnet crown (PMC) drivers).

### BACKGROUND

FIG. 1 is a prior art audio force transducer 100 that includes a fixed magnetic flux path 101 (soft iron) having permanent magnets 102 and a sliding coil holder (also called an “armature”) 103 having electric coil (also called a “voice coil”) 104. The permanent magnets 102 are separated from the electric coil 104 with an air gap 105. The magnetic forces will cause the coil holder 103 to slide inward and outward in the z-axis direction (as shown in FIG. 1), which moves the panels of the loudspeakers (not shown) to produce the auditory sound.

As disclosed and taught in Pinkerton '633 PCT Application, large pressure forces on a sound panel (of an audio speaker) can be cancelled, or partially cancelled, by using a magnetic negative spring (MNS) as part of a reluctance assist driver (RAD) or a permanent magnet crown (PMC) driver.

FIG. 2A (which is FIG. 18D of the Pinkerton '633 PCT Application) shows a perspective view showing certain parts (mainly the permanent magnets) of a repulsive/attractive MNS. FIG. 2B shows a perspective view of the armature that was utilized in the repulsive/attractive MNS shown in FIG. 2A.

As shown in FIGS. 2A-2B (which provides movement of the coil holder along the z-direction), the voice coils are always immersed in the magnetic field (which makes the force per unit current input approximately constant at all armature positions).

The repulsive/attractive MNS shown in FIGS. 2A-2B has stationary magnetic poles (such as stationary magnetic north poles 1801a-1804a and stationary magnetic south poles 1801b-1804b), which are made with permanent magnets (in place of steel) and so the oppositely polarized moving magnets (such as moving magnetic north poles 1805a-1806a and moving magnetic south poles 1805b-1806b) on the armature are radially repelled by the stationary magnet poles (which provides radial stability). As shown in FIGS. 2A-2B, the stationary magnetic poles are permanent magnet rings (PMRs) and the moving magnetic poles are permanent magnetic triangles (PMTs). The PMR could be an assemblage of arc segments that, when combined, create a ring magnet structure.

When the armature is in the centered position (as shown in FIG. 2C, which is FIG. 18A of the Pinkerton '633 PCT Application), the positive z-direction array of PMT (moving magnetic north pole 1806a and moving magnetic south pole 1806b) is immersed in the oppositely directed magnetic field of the positive z-direction PMR (stationary magnetic north poles 1802a and 1804a and stationary magnetic south poles 1802b and 1804b) and thus is radially stable.

When the armature is in the partial negative z-direction position (as shown in FIG. 2D, which is FIG. 18B of the Pinkerton '633 PCT Application), this position the positive z-direction array of PMT (moving magnetic north pole 1806a and moving magnetic south pole 1806b) is partially immersed in the oppositely directed magnetic field of the positive z-direction PMR (stationary magnetic north poles 1802a and 1804a and stationary magnetic south poles 1802b and 1804b) and still radially stable. The axial/desired force in this position is high because the positive z-direction array of PMT (moving magnetic north pole 1806a and moving magnetic south pole 1806b) is being repelled by the positive z-direction PMR (stationary magnetic north poles 1802a and 1804a and stationary magnetic south poles 1802b and 1804b) and attracted by the magnetic fringing fields of negative z-direction PMR (stationary magnetic north poles 1801a and 1803a and stationary magnetic south poles 1801b and 1803b).

When the armature is in the full negative z-direction position (as shown in FIG. 2E, which is FIG. 18C of the Pinkerton '633 PCT Application), the positive z-direction array of PMT (moving magnetic north pole 1806a and moving magnetic south pole 1806b) is not immersed in the oppositely directed magnetic field of the positive z-direction PMR (stationary magnetic north poles 1802a and 1804a and stationary magnetic south poles 1802b and 1804b), but is partially immersed in the magnetic fringing field of the negative z-direction PMR (stationary magnetic north poles 1801a and 1803a and stationary magnetic south poles 1801b and 1803b) and this position still provides some radially stability. The axial/desired force in the position shown in FIG. 18C is also high because the positive z-direction array of PMTs is being repelled by the positive z-direction PMR magnetic fringing field and attracted by the negative z-direction PMR.

By symmetry, this same stability will be provided when the armature moves in the positive z-direction.

This provides a radial stabilizing force that helps to keep the armature centered within the air gap between the inner and outer permanent magnet rings.

FIG. 3 (which is FIG. 20 of the Pinkerton '633 PCT Application) shows a loudspeaker 2000 in which an MNS (such as shown in FIGS. 2A-2B) can be utilized. Loudspeaker 2000 has a sealed chamber (or sealed enclosure) 2001, a movable panel 2002 (which is connected to a flexible “surround” element 2005, such as made from rubber to allow movable panel 2002 to move in the positive and negative z-direction). Loudspeaker 2000 further includes MNS 2003, and voice coil 2004, which are positioned for moving movable panel 2002 in the positive and negative z-direction. Loudspeaker 2000 further includes sensor 2006 (such as position and/or velocity sensor, that can be an optical or inductive sensor) used to provide position or velocity feedback to a control circuit). In the orientation of FIG. 3 (shown by the x-z axis shown therein, with the y-direction perpendicular thereto), movable sound panel 2002 moves outward and inward in the z-direction due to the z-direction movement of the armature. Such movement occurs due to the magnetic forces generated thereby.

When the sound panel is in its neutral/relaxed position, there are no forces acting on movable sound panel 2002. When movable sound panel 2002 moves in the positive z-direction, this creates a partial vacuum (i.e., a decrease in pressure) in sealed chamber 2001. When movable sound panel 2002 moves in the negative z-direction, this creates an increased pressure in sealed chamber 2001. Thus, there are additional forces that are created by this movement due to the decrease/increase in pressure.

Loudspeakers thus utilize power to move the movable sound panel, including to overcome the various forces. Accordingly, a need exists to reduce the power that is utilized to move the movable sound panel in the loudspeakers.

### SUMMARY OF THE INVENTION

The present invention is directed to electroacoustic drivers that can be utilized in loudspeaker systems that utilize drivers having a magnetic negative spring (MNS). A variable volume device, such as a bellow, is used to vary the enclosed air volume of the sealed chamber of the loudspeaker.

In general, in one aspect, the invention features a loudspeaker. The loudspeaker includes a sealed enclosure. The loudspeaker further includes a sound panel mechanically connected to the sealed enclosure. The loudspeaker further includes a moveable armature mechanically connected to the sound panel including an actuator operable to convert electrical energy into mechanical energy. The loudspeaker further includes a plurality of ferromagnetic elements mechanically connected to the moveable armature. The loudspeaker further includes a variable volume device placed within the sealed enclosure.

Implementations of the invention can include one or more of the following features:

The variable volume device can be a variable air volume device.

The variable volume device can include a bellow.

The variable volume device can be an electrically operated variable volume device.

The variable volume device can be operable to create a positive pressure within the sealed enclosure.

The variable volume device can be operable to create a negative pressure within the sealed enclosure.

The variable volume device can include a first valve having an inlet. The variable volume device can further include a second valve having an outlet. The variable volume device can further include a pump flowably connected to the first valve and the second valve. The variable volume device can further include a conduit to outside the sealed enclosure, with the conduit is flowably connected to the first and second valve. The variable volume device can further include an electronic switch operable to operate the pump, the first valve, and the second valve. The operation of the pump can permit the flow of air through the variable volume device such that (A) the air flows from the first valve to the pump, and (B) the air flows from the pump to the second valve. The operation of the electronic switch can provide for the first valve and the second value to be set in a positive pressure setting in which air pressure is increased in the sealed enclosure. When the pump is flowing air and when the first valve is in the positive pressure setting, the first valve (I) cannot permit the flow of air through the inlet, and (II) can permit the flow of air from outside the sealed enclosure, through the conduit, and to the first valve. When the pump is flowing air and when the second valve is in the positive pressure setting, the first valve (I) cannot permit the flow of air between the outside of the sealed enclosure and the second valve through the conduit, and (II) can permit the flow of air from the second valve, through the outlet, and to the sealed enclosure. The operation of the electronic switch can provide for the first valve and the second value to be set in a negative pressure setting in which air pressure is decreased in the sealed enclosure. When the pump is flowing air and when the first valve is in the negative pressure setting, the first valve (I) can permit the flow of air from the sealed enclosure, through the inlet, and to the first valve, and (II) cannot permit the flow of air between the outside the sealed enclosure and the first valve through the conduit. When the pump is flowing air and when the second valve is in the negative pressure setting, the first valve (I) can permit the flow of air from the second valve, through the conduit, to the outside of the sealed enclosure, and (II) cannot permit the flow of air through the outlet.

The electronic switch can be operable to switch the first valve and second valve between the positive pressure settings and the negative pressure settings by reversing polarity of the switch.

The loudspeaker can further include a position sensor operable for sensing the position of the sound panel.

The position sensor can include a card having a plurality of windows.

The position sensor can further include a light source on a first side of the plurality of windows. The position sensor can include a photodetector on a second side of the plurality of windows. The plurality of windows can be operable to intermittently permit light from the light source to pass through to the photodetector.

The light source can be an LED source. The light from the light source can be infrared light.

The loudspeaker can further include an electronic controller.

The loudspeaker of claim 1 can further include a position sensor and an electronic controller.

The variable volume device can include an electric motor that is operable to change the volume of the variable volume device.

The loudspeaker can further include a position sensor, an electronic controller, and an electric motor that is operable to change the volume of the variable volume device.

The electric motor can be powered by the electronic controller in response to the location of the sound panel as measured by the position sensor.

The actuator can be a voice coil.

The plurality of ferromagnetic elements can be operable for creating a first magnetic force when the sound panel moves away from the sealed enclosure and a second magnetic force with the sound panel moves toward the sealed enclosure.

The first magnetic force and second magnetic force can be oppositely directed.

The variable volume device can be operable to create a negative pressure within the sealed enclosure creating a first mechanical force on the sound panel.

The variable volume device can be operable to create a positive pressure within the sealed enclosure creating a second mechanical force on the sound panel.

The first mechanical force and second mechanical force can be oppositely directed.

The first magnetic force and first mechanical force can be oppositely directed.

The second magnetic force and second mechanical force can be oppositely directed.

The variable volume device can be operable to move the sound panel to a location near the midpoint of its range of motion.

The variable volume device can be operable to move the average position of the sound panel to a location near the midpoint of its motion.

The variable volume device can include a linear actuator.

The variable volume device can include a lead screw.

The variable volume device can include a linear actuator that can vary the volume of a bellows.

The linear actuator can be an electrically powered linear actuator.

The plurality of ferromagnetic elements can include a plurality of permanent magnets.

The electronic controller can be operable for analyzing a song file to determine the amplitude, frequency, and prevalence of the musical notes within the song file.

The electronic controller can be operable for computing the determined target volume of the variable volume device and for sending a signal to the variable volume device to adjust the volume of the variable volume device so that it is near the determined target volume.

The determined target volume can be the volume that minimizes the average power consumption of the actuator.

The determined target volume can be the volume that maximizes the average sound pressure level that is produced by the sound panel.

The loudspeaker can further include a pneumatic valve that pneumatically connects the air within the sealed enclosure with the air outside of the sealed enclosure.

The loudspeaker can further include an electronic controller that is electrically connected to the pneumatic valve.

The loudspeaker can further include a pneumatic connection between the air inside of the bellows and the air outside of the sealed enclosure.

The loudspeaker can further include a magnetic negative spring (MNS). The MNS can include the plurality of ferromagnetic elements mechanically connected to the moveable armature. The MNS can further include a stationary core assembly including a plurality of stationary ferromagnetic elements.

The MNS can be a reluctance assistance driver (RAD).

The MNS can be a permanent magnet crown (PMC) driver.

The sealed enclosure can include a sealed enclosure boundary on a side opposite the sound panel. The sealed enclosure boundary can be anchored to the stationary core assembly.

The sealed enclosure boundary can be bolted to the stationary core assembly.

The sealed enclosure boundary can be a cap that is bolted to the stationary core assembly.

When the sound panel moves in a first direction outward from the sealed enclosure to create a negative pressure within the sealed enclosure, the sealed enclosure boundary can provide a first force in the first direction upon the stationary core assembly. When the sound panel moves in a second direction inward to the sealed enclosure to create a positive pressure within the sealed enclosure, the sealed enclosure boundary can provide a second force in the second direction upon the stationary core assembly.

The first force in the first direction provided by the sealed enclosure boundary can cancel, at least in part, a first resulting force in the second direction upon the stationary core assembly resulting from the sound panel moving in the first direction. The second force in the second direction provided by the sealed enclosure boundary can cancel, at least in part, a second resulting force in the first direction upon the stationary core assembly resulting from the sound panel moving in the second direction.

In general, in another aspect, the invention features a loudspeaker. The loudspeaker includes a sealed enclosure. The loudspeaker further includes a sound panel mechanically connected to the sealed enclosure. The loudspeaker further includes a moveable armature mechanically connected to the sound panel including an actuator operable to convert electrical energy into mechanical energy. The loudspeaker further includes a position sensor placed near the sound panel. The loudspeaker further includes an electronic controller electrically connected to the position sensor that is operable to determine the average position of the sound panel and using the average position to calculate the average air pressure within the sealed enclosure.

In general, in another aspect, the invention features a loudspeaker. The loudspeaker includes a sealed enclosure that contains an average volume of air. The loudspeaker further includes a sound panel mechanically connected to the sealed enclosure. The loudspeaker further includes a moveable armature mechanically connected to the sound panel including an actuator operable to convert an electrical signal into mechanical movement. The loudspeaker further includes a position sensor placed near the sound panel. The loudspeaker further includes an electronic controller electrically connected to the position sensor that can use the position of the sound panel and average volume of air to calculate the air pressure within the sealed enclosure.

In general, in another aspect, the invention features a loudspeaker. The loudspeaker includes a sealed enclosure. The loudspeaker further includes a sound panel having a panel area that is mechanically connected to the sealed enclosure. The loudspeaker further includes a moveable armature mechanically connected to the sound panel including an actuator operable to convert an electrical signal into mechanical motion. The loudspeaker further includes a position sensor that can measure the position of the sound panel. The loudspeaker further includes a microphone located outside of the sealed chamber. The loudspeaker further includes an electronic controller electrically connected to the position sensor and microphone.

Implementations of the invention can include one or more of the following features:

The controller can use information from the position sensor to calculate the mechanical frequency and amplitude of the sound panel.

The controller can use the panel area, mechanical frequency and amplitude of the sound panel to estimate a first sound pressure level.

The controller can use the signal from the microphone to estimate a second sound pressure level.

The controller can use the first sound pressure level and second sound pressure level to adjust the electrical signal.

In general, in another aspect, the invention features a loudspeaker. The loudspeaker includes a sealed enclosure. The loudspeaker further includes a sound panel mechanically connected to the sealed enclosure. The loudspeaker further includes a moveable armature mechanically connected to the sound panel including an actuator operable to convert electrical energy into mechanical energy. The loudspeaker further includes a pump-valve operable to change the air pressure within the sealed enclosure. The loudspeaker further includes a position sensor. The loudspeaker further includes an electronic controller electrically connected to the position sensor and pump-valve that is operable to move the armature near its centered position.

In general, in another aspect, the invention features a loudspeaker. The loudspeaker includes a sealed enclosure. The loudspeaker further includes a sound panel mechanically connected to the sealed enclosure. The loudspeaker further includes a moveable armature mechanically connected to the sound panel including an actuator operable to convert electrical energy into mechanical energy. The loudspeaker further includes a pump-valve operable to change the air pressure within the sealed enclosure. The loudspeaker further includes a position sensor. The loudspeaker further includes an electronic controller electrically connected to the position sensor and pump-valve that is operable to move the average position of the armature near its centered position.

In general, in another aspect, the invention features a loudspeaker. The loudspeaker includes a sealed enclosure. The loudspeaker further includes a sound panel mechanically connected to the sealed enclosure. The loudspeaker further includes a moveable armature mechanically connected to the sound panel including an actuator operable to convert electrical energy into mechanical energy. The loudspeaker further includes a magnetic negative spring (MNS). The MNS includes a plurality of ferromagnetic elements mechanically connected to the moveable armature. The MNS further includes a stationary core assembly comprising a plurality of stationary ferromagnetic elements. The sealed enclosure includes a sealed enclosure boundary on a side opposite the sound panel. The sealed enclosure boundary is anchored to the stationary core assembly.

In general, in another aspect, the invention features a method. The methods includes selecting a loudspeaker from the loudspeakers disclosed and taught herein. The method further includes utilizing the loudspeaker to produce sound.

### DESCRIPTION OF DRAWINGS

FIG. 1 (which is FIG. 1 of the Pinkerton '633 PCT Application) is a schematic of a cross-sectional view of a prior art audio force transducer.

FIG. 2A (which is FIG. 18D of the Pinkerton '633 PCT Application) is an illustration

of a perspective view showing certain parts (mainly the permanent magnets) of a prior art repulsive/attractive MNS (which is shown in FIGS. 2C-2E).

FIG. 2B is an illustration of a perspective view of the armature that was utilized in the prior art repulsive/attractive MNS shown in FIG. 2A.

FIGS. 2C-2E (which are, respectively, FIGS. 18A-18C of the Pinkerton '633 PCT Application) are schematics of a cross-sectional view of an embodiment of a prior art repulsive/attractive MNS with the voice coil armature in various positions (centered, partial negative z-direction, centered, and full negative z-direction, respectively).

FIG. 3 (which is FIG. 20 of the Pinkerton '633 PCT Application (with a change of orientation of the z-axis)) is a schematic of a loudspeaker in which an MNS (such as shown in FIG. 2A) can be utilized.

FIG. 4 is a graph showing sound pressure level and voice coil power as a function of frequency.

FIGS. 5A-5B are schematics of a loudspeaker of the present invention showing, respectively, a contracted and expanded bellow.

FIGS. 6A-6C illustrate a position sensor that can be used in embodiments of the present invention.

FIG. 7 shows another embodiment of the present invention having a variable volume device.

FIGS. 8A-8B are schematic diagrams the variable volume device of FIG. 7.

FIG. 9 shows a cross section of another embodiment of the present invention.

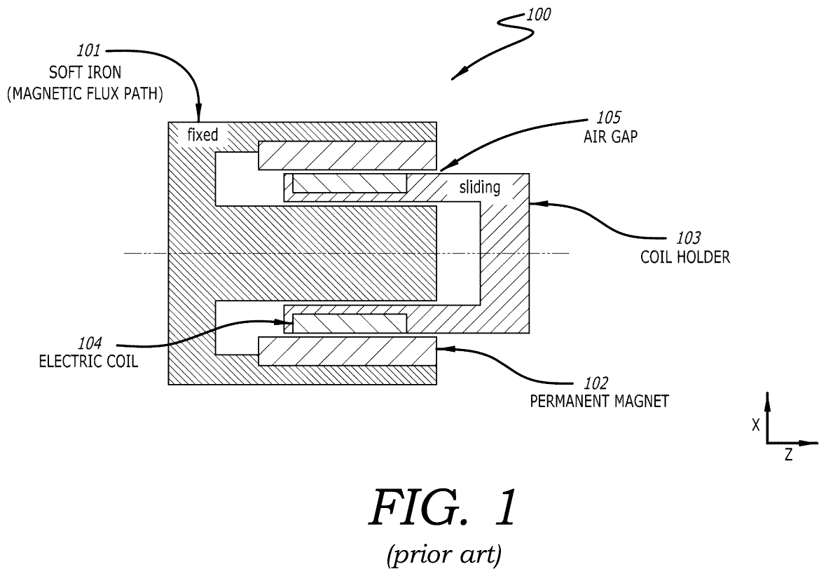

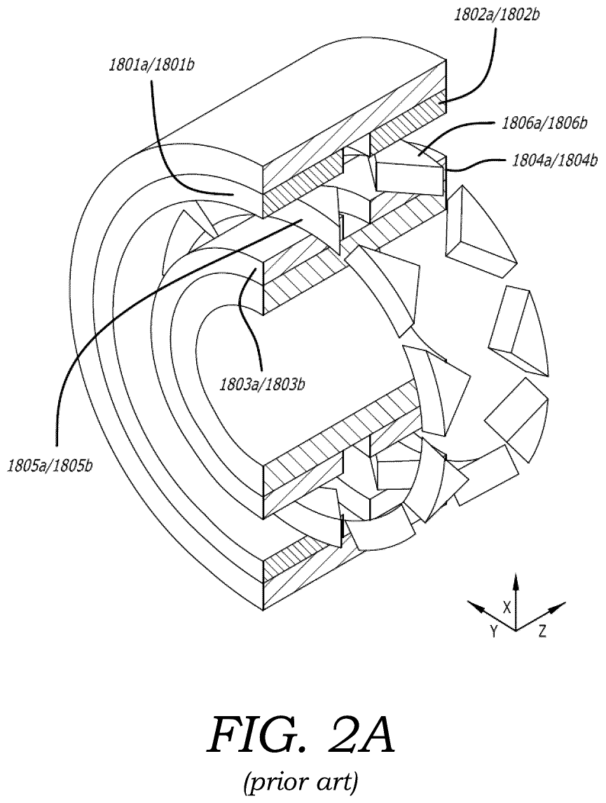

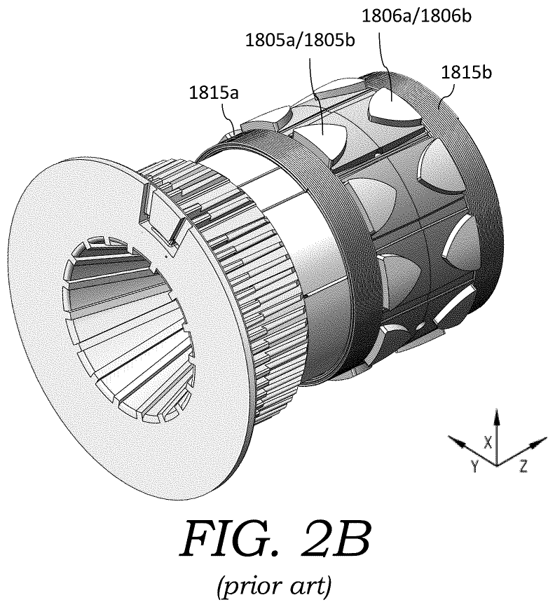

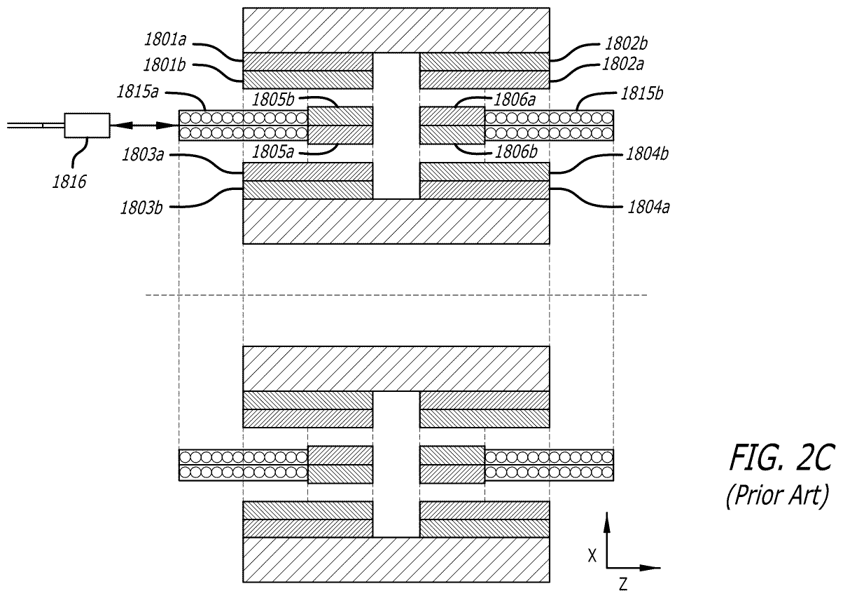

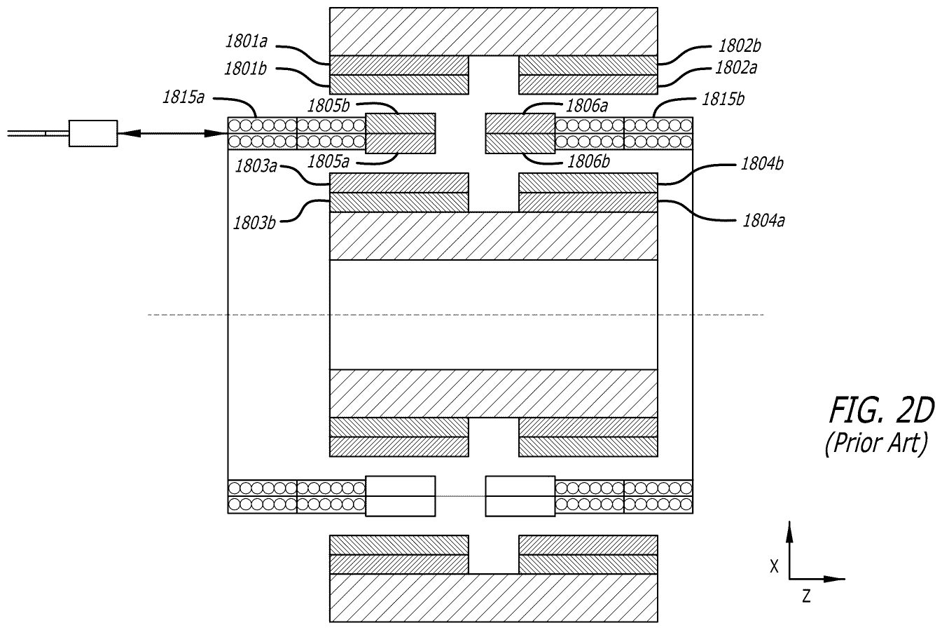

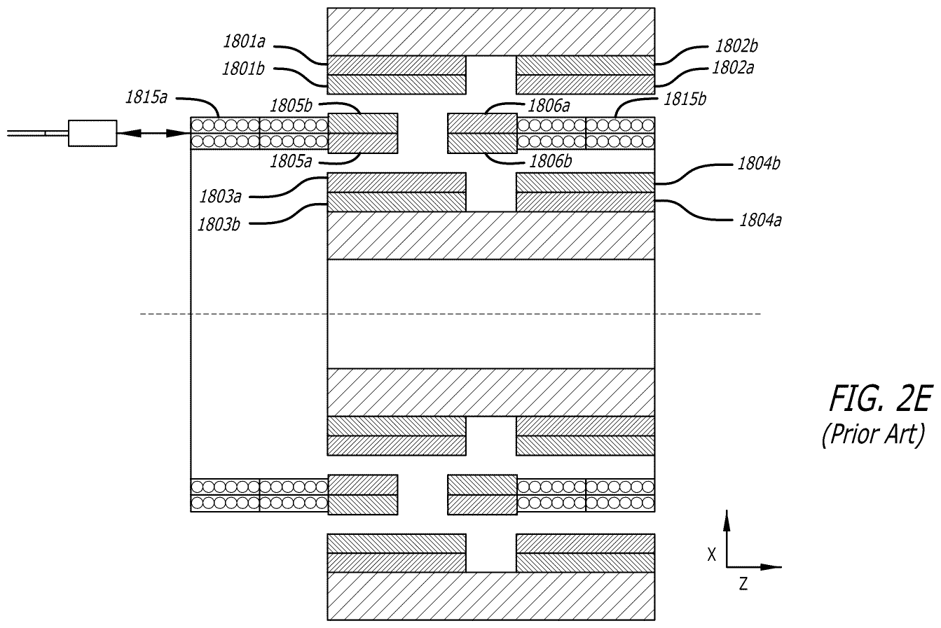

### DETAILED DESCRIPTION

The present invention is directed to loudspeakers and methods of use thereof, and in particular loudspeakers having drivers including a magnetic negative spring (MNS) (such as reluctance assist drivers (RAD) and permanent magnet crown (PMC) drivers). The loudspeakers include a system that provides makes it possible to lower voice coil power of the loudspeaker by adjusting the mechanical resonant frequency of the armature-panel assembly by the system adjusting the internal air volume of the loudspeaker.

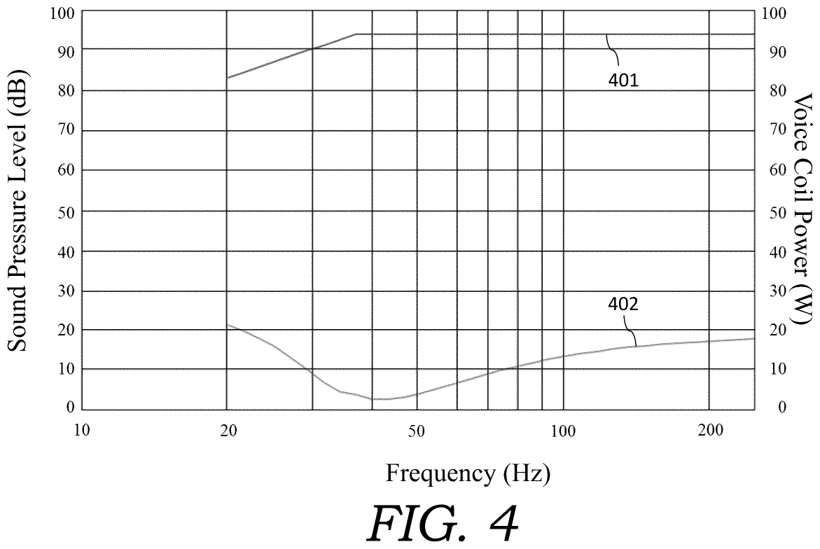

FIG. 4 is a graph showing sound pressure level (curve 401) and voice coil power (curve 402) as a function of frequency. Curve 402 shows the voice coil power required to move the movable sound panel 6 mm in the positive z-direction and 8 mm in the negative z-direction. As shown by curve 402, the voice coil power is under 3 W at the resonant frequency of the loudspeaker (which is around 40 Hz in this case) and between 3 W and 20 W above and below this resonant frequency.

Most songs have a main subwoofer note that repeats throughout the song so matching the armature resonant frequency with the song note frequency will minimize voice coil power consumption. It is possible to look ahead in a song file before it is played to determine the main subwoofer note frequency (which is termed here as the “song determined resonant frequency.” If the loudspeaker is connected to Wi-Fi, it is also possible to search for, locate and review the entire song within the first few seconds of playing a song to help determine the song determined resonant frequency.

If the main subwoofer note is 30 Hz and the resonant frequency of the loudspeaker is moved to 30 Hz (from 40 Hz), the voice coil power can drop from 10 watts to 2.8 watts according to curve 402. Also, since the stiffness of the speaker spider supports tends to decline over time, it is desirable to compensate for this decline by gradually increasing the stiffness of the sealed chamber air spring constant.

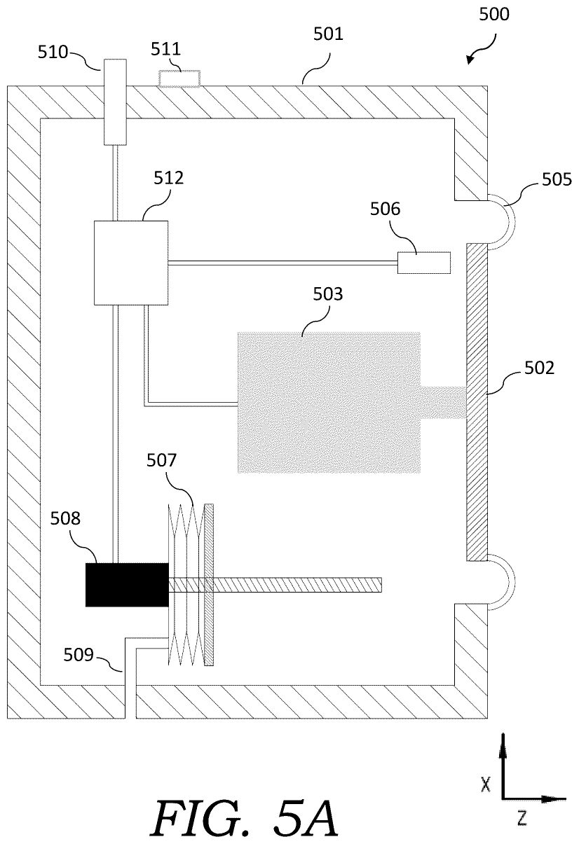

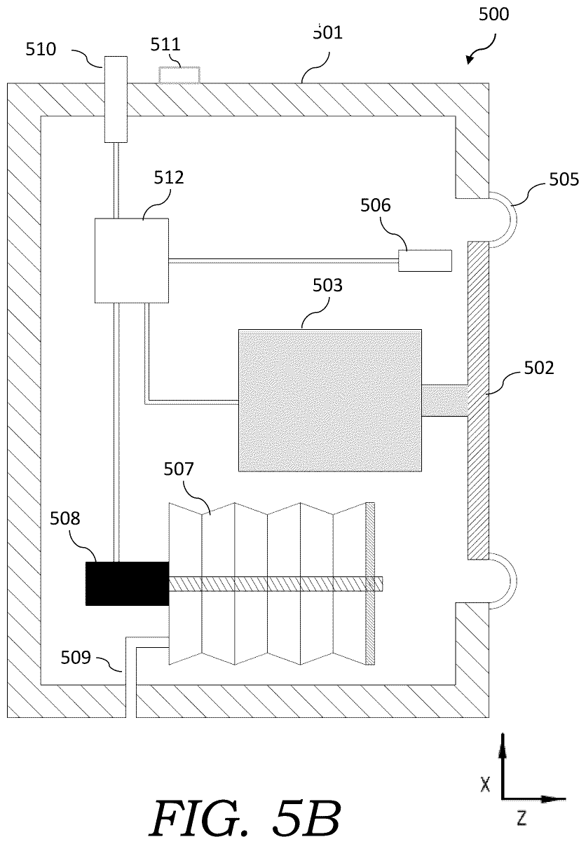

One way to adjust the internal air volume (and thus the resonant frequency) of the loudspeaker is by using a variable volume device (or system) that includes an internal bellows with an associated motor to adjust the volume of the bellows. FIGS. 5A-5B show a loudspeaker 500 having a sealed chamber (or sealed enclosure) 501, a movable sound panel 502, (which is connected to a flexible “surround” element 505, such as made from rubber to allow movable sound panel 502 to move in the positive and negative z-direction). Loudspeaker 500 further includes armature assembly 503 (including the MNS and voice coil), which is positioned for moving movable sound panel 502 in the positive and negative z-direction. Loudspeaker 500 further includes sensor 506 (such as position and/or velocity sensor, that can be an optical or inductive sensor) used to provide position or velocity feedback to electronic controller 512. In the orientation of FIG. 5 (shown by the x-z axis shown therein, with the y-direction perpendicular thereto), movable sound panel 502 moves outward and inward in the z-direction due to the z-direction movement of the armature. Such movement occurs due to the voice coil and magnetic negative spring forces generated thereby.

Loudspeaker 500 further includes a variable volume device, such as bellows 507, with an associated motor 508 (for adjusting the volume of bellows 507). Air outside loudspeaker 500 can flow in and out of bellows 507 (to permit the bellows to contract or expand) via conduit 509. FIG. 5A shows bellows 507 when contracted, and FIG. 5B shows bellows 507 when expanded. Expanding or contracting bellows 507 will temporarily increase or decrease the internal air pressure of the chamber but this pressure will equilibrate in a few seconds given any small air leaks that exist in sealed chamber 501. Electronic controller 512, a pump-valve 510 can also be utilized to facilitate and control this pressure equalization by pumping air into or out of sealed chamber 501 to create positive, negative or near zero pressure within sealed chamber 501. Increasing the stiffness of the chamber air spring constant (by decreasing the chamber air volume with an expanded bellows 507 like shown in FIGS. 5B) will increase the resonant frequency. Decreasing the air chamber spring constant (by increasing the chamber air volume with a contracted bellows 507 like shown in FIG. 5A) will decrease the resonant frequency. Thus, the resonant frequency can be controlled using electronic controller 512 by controlling the degree to which the bellows is expanded/contracted. Loudspeaker 500 can also have a microphone 511, which, in addition to the typical/standard uses of speaker microphones, can be used for determining and controlling resonant frequency.

In a comparison between using bellows in (a) an exemplar MNS loudspeaker and (b) a comparison conventional loudspeaker in which the sound panel displacement is the same (150 cc), it was found that utilizing the variable volume device works well with a MNS speaker but not with a conventional speaker. A plus or minus 100 cc adjustment in internal air volume shifts the resonant frequency of a MNS speaker from 61 Hz to 35 Hz but does not shift it a meaningful amount for a conventional speaker. This characteristic is because a MNS speaker is able to use a much smaller sealed enclosure (as 100 cc is a much larger fraction of total sealed enclosure air volume). (By comparison, an internal bellows that can be adjusted ±100 cc, can adjust the internal air volume of the exemplar MNS loudspeaker between 1200 cc and 1400 cc, while only adjusting the internal air volume of a comparative conventional loudspeaker between 12900 cc and 13100 cc.) This characteristic is also because the net stiffness of a MNS speaker can be made very low by balancing the spider plus air pressure forces with the opposing MNS force (so a small change in chamber air spring constant can significantly change the total armature-panel mechanical stiffness).

In some embodiments of the present invention, the internal air pressure of sealed chamber 501 that contains a known volume of internal air can be measured by using the position of movable sound panel 502 (such as measured by a position sensor 506). This provides an incrementally free internal pressure sensor that can be used to coordinate the operation of bellows 507 and pump-valve 510 (use for pressure equalization).

In addition to adjusting the mechanical resonant frequency (and thus minimizing power consumption), the variable volume device of loudspeaker 500 can also be utilized to replace the centering mechanism needed to “launch” the MNS armature. When loudspeaker 502 is powered off, armature assembly 503 will make movable sound panel 502 land in one of the two extreme positions (i.e., movable sound panel 502 will be all the way in or out of sealed chamber 501 at that point). When loudspeaker 500 is turned on, bellows 507 can be compressed to create a vacuum (if movable sound panel 502 is out) or expanded to create positive pressure (if movable sound panel 502 is in). Pump-valve 510 can also be used to create positive and negative pressure as needed to center movable sound panel 502. The pressure on movable sound panel 502 will move it toward its centered position where the relatively weak voice coil of armature assembly 503 can take over. This approach has advantages over the previous centering mechanisms in that this allows the armature to be lighter and enables the centering mechanism to use fewer moving parts.

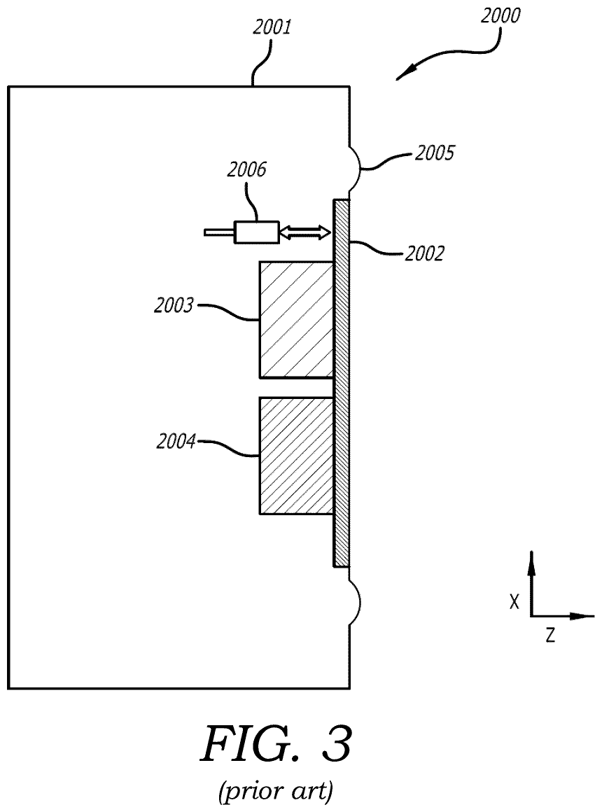

Another function that can be the variable volume device of the loudspeaker is to balance the movable panel motion so it is symmetrical around the centered position of the armature. Referring to loudspeaker shown in FIG. 3, the decrease and increase in pressure force is not symmetrical. The movement of the panel in the negative z-direction (which increases pressure) requires a greater force to move a particular distance, as compared to the movement of the same particular distance in the positive z-direction (which decreases pressure). This pressure differential is due to the fact that sealed chamber 2001 is relatively smaller when the panel moves in the negative z-direction than when the panel moves in the positive z-direction.

For instance, movable sound panel 502 creates more pressure when moving in (negative z-direction) than out (positive z-direction) so for example movable sound panel 502 may move about 6 mm inward and 8 mm outward. Bellows 507 of the variable volume device or the active pump-valve 510 can be used to create a slight vacuum during large subwoofer notes so that movable sound panel 502 will move plus/minus 8 mm around its centered position. This allows movable sound panel 502 to move ±8 mm or 16 mm peak-to-peak (verses 14 mm peak-to-peak without the use of a slight vacuum) to increase sound pressure level without movable sound panel 502 hitting its mechanical limits.

In some embodiments, sensor 506 (such as a position sensor), microphone 511, and electronic controller 512 can be used to calculate the difference between the sound pressure level that is created by movable sound panel 502 and the sound pressure level that is measured by microphone 511 (or group of microphones) located outside of sealed chamber 501. If loudspeaker 500 is in an open area (outside or in a huge room), these signals will be nearly the same; but if loudspeaker 500 is near a wall, in a corner, on a bookshelf, etc., these signals will vary substantially. Electronic controller 512 can use the difference between the two signals to vary the actuator input signal so that loudspeaker 500 has the optimal equalization (EQ) for each loudspeaker placement/location.

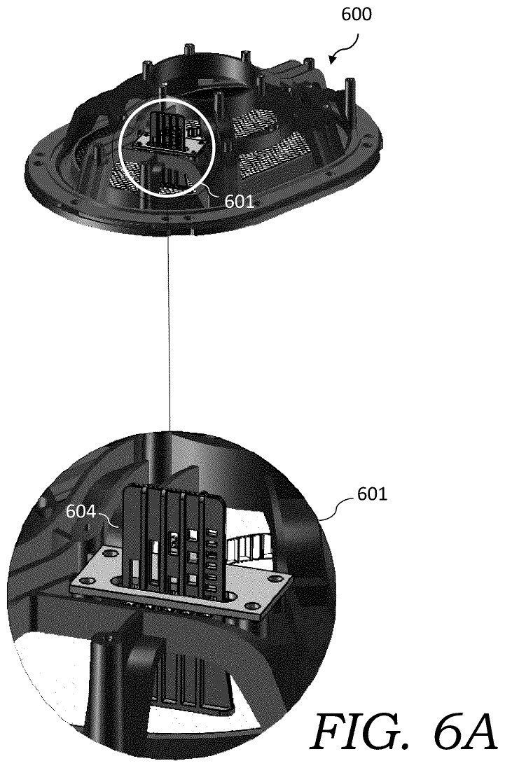

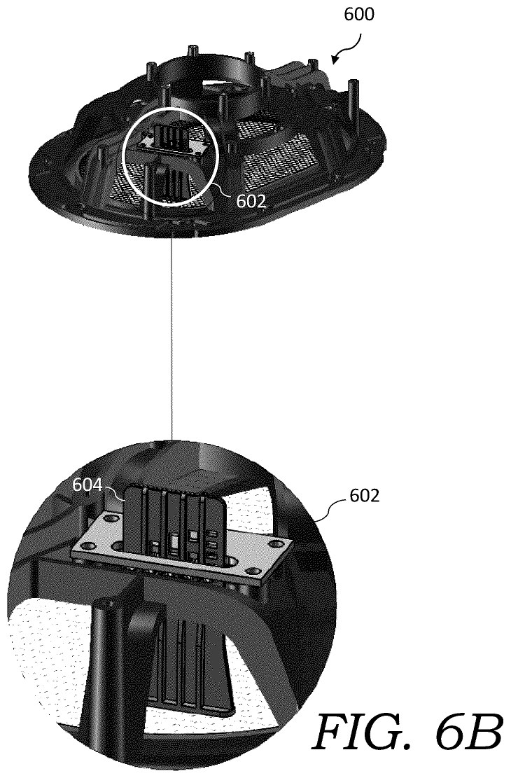

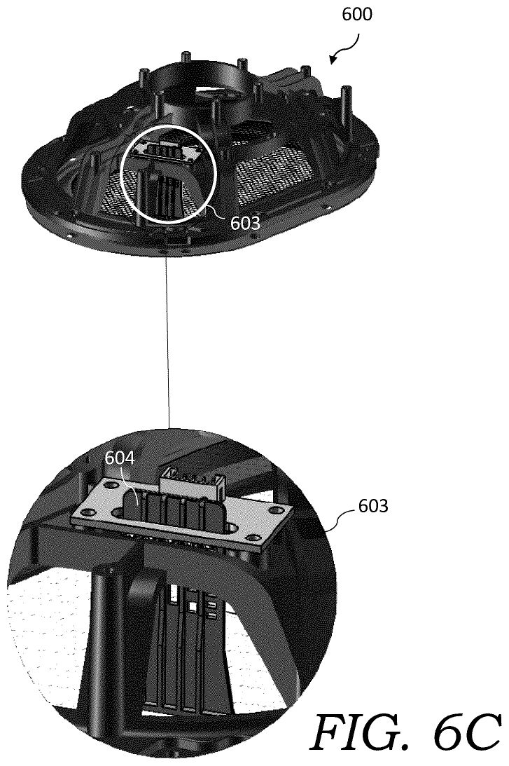

FIGS. 6A-6C provide additional details of an embodiment of a position sensor 506 that can be used in embodiments of the present invention. In such position sensor 506, a card 604 (such as a plastic card) with a series of open windows is adhered to the sound panel. As card 604 moves out and in with panel 502 (as shown in magnified portions 601-603 of the RAD driver basket 600 shown in FIGS. 6A-6C, (respectively), the open windows intermittently allow infrared light to pass from an LED source on one side of the card 604 to a photodetector on the opposite side of the card. As shown in FIGS. 6A-6C, there are five channels (vertical arrays of widows) that each have a specific pattern of open windows. The five infrared signals are used to determine if the panel is fully in (FIG. 6A), centered (FIG. 6B), fully out (FIG. 6C) or somewhere in-between these three positions.

This position sensor can be used in connection with the valve-pump system to center the armature using relatively low power (approximately one watt). The position sensor can also be used to make sure that the sound panel excursion never exceeds its rated value. Cost and space in the loudspeaker system are conserved by integrating the position sensor into the RAD driver plastic basket, which is the basket that mechanically supports the sound panel, stator magnets and armature) as described and discussed above.

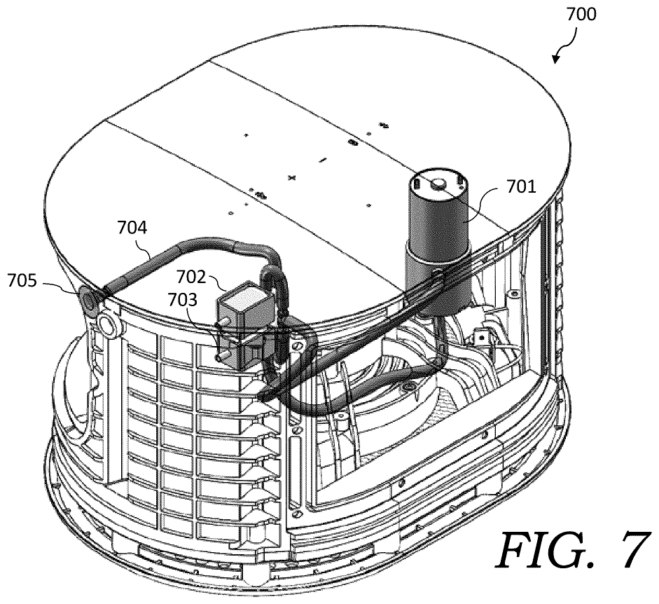

FIG. 7 shows another embodiment of the present invention having a variable volume device. In this embodiment, the variable volume device that is used to vary the enclosed air volume of the sealed chamber of the loudspeaker 700 by operating to create positive and negative air pressure within the sealed chamber (or sealed enclosure). The variable volume device includes a pump 701, valves 702-703, and tube fitting 704 (or tube conduit) that leads to outside the sealed chamber. Optionally, the tube fitting 704 can have a waterproof material (or cover) 705 that can allow air to flow in and out, but preclude the flow of liquids, such as water, in and out of the sealed chamber.

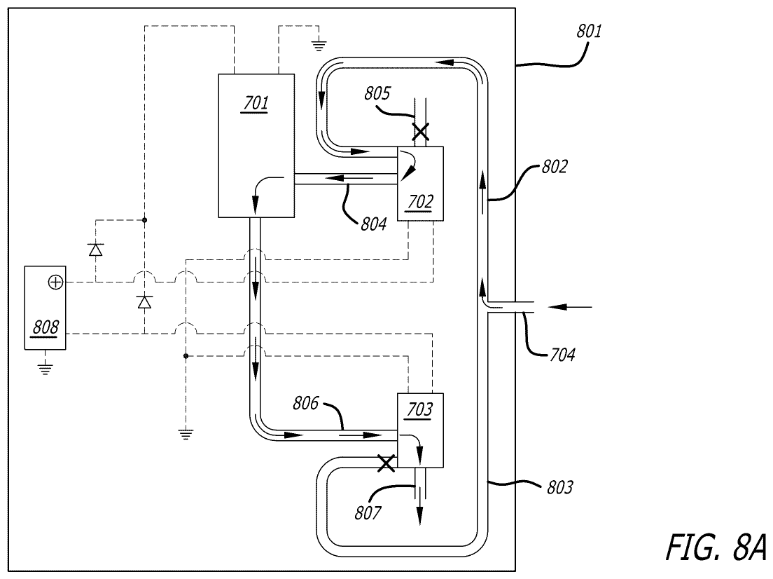

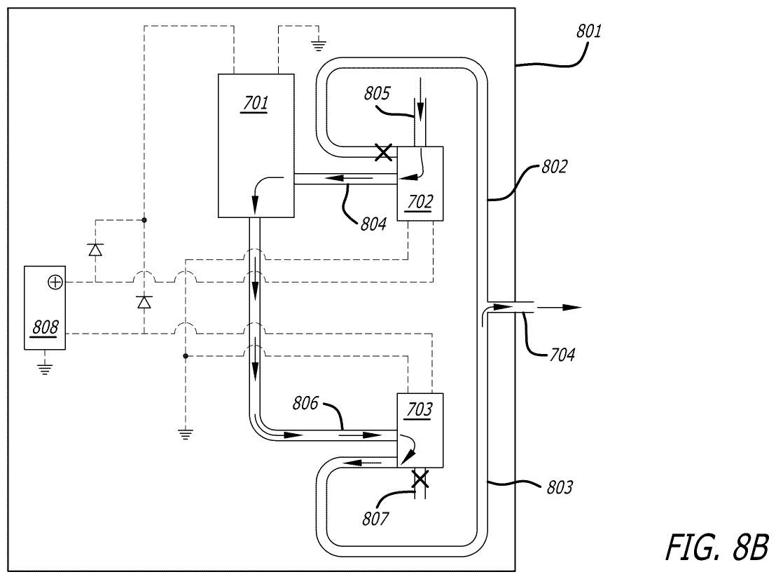

FIGS. 8A-8B show schematic diagrams of how the variable volume device of FIG. 7 operates to create positive and negative pressure within sealed chamber 801.

Positive pressure within sealed chamber 801 can be created by operating electronic switch 808 such that it routes voltage and current to operate pump motor 701 and also to operate the two valves 702-703 to permit the flow as shown by the air flow arrows shown in FIG. 8A. Valve 702 is operated such that inlet 805 is closed and tubing 802 is opened, which provides for air to flow (a) from outside sealed chamber 801, though tube fitting 704, and to valve 702, and (b) from valve 702, through tubing 804, and to pump 701. Valve 703 is operated such that outlet 807 is opened and tubing 803 is closed, which provides for air to flow (c) from pump 701, through tubing 806, and to valve 703, and (d) from valve 703, through outlet 807, and to sealed chamber 801.

Negative pressure within sealed chamber 801 can be created by operating electronic switch 808 (to reverse its polarity) such that it routes voltage and current to operate pump motor 701 and also to operate the two valves 702-703 to permit the flow as shown by the air flow arrows shown in FIG. 8B. Valve 702 is operated such that inlet 805 is opened and tubing 802 is closed, which provides for air to flow (a) from sealed chamber 801, through inlet 805, and to valve 702, and (b) from valve 702, through tubing 804, and to pump 701. Valve 703 is operated such that outlet 807 is closed and tubing 803 is opened, which provides for air to flow (c) from pump 701, through tubing 806, and to valve 703, and (d) from valve 703, through tubing 803, and to outside sealed chamber 801.

Such an arrangement provides a cost-effective way to center the armature and adjust internal air pressure as needed to optimize audio performance.

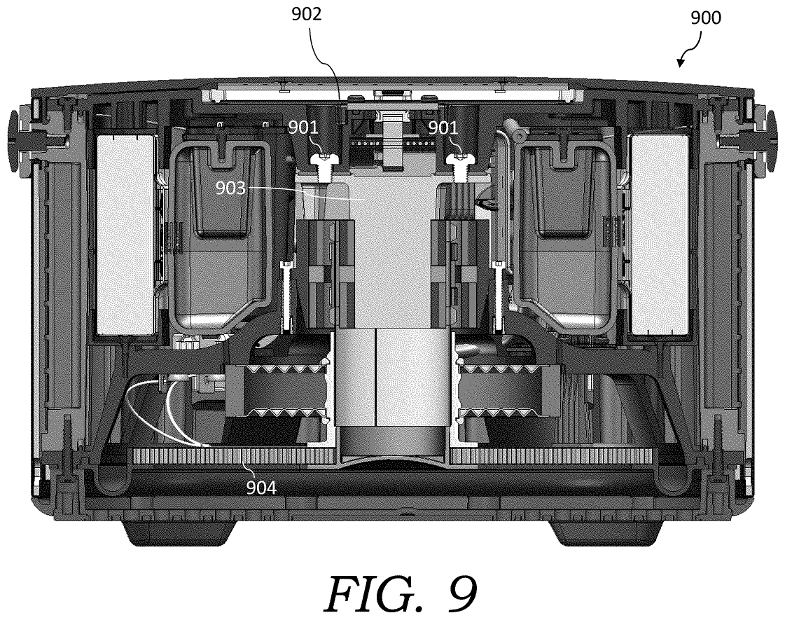

FIG. 9 shows a cross section of another embodiment of the present invention. As described and discussed above, a RAD driver produces much higher air pressure variations within the sealed chamber than a conventional speaker (on the order of plus/minus 10,000 Pascals). These pressure variations create large mechanical forces on all parts of the sealed chamber and significant mechanical motion of the relatively flat top part of the chamber. As shown in loudspeaker 900 shown in FIG. 9, to significantly reduce the mechanical motion of top cap 902, screws 901 were used to bolt RAD magnetic circuit or “core” assembly 903 to top cap 902 as shown. In addition to mechanical support, this design uses internal air pressure variations to counter the high inertial forces of the RAD driver.

When sound panel 904 is being pushed outward, which is downward in the orientation of loudspeaker 900 (creating a partial vacuum in the sealed chamber that creates a downward force on top cap 902) it creates a reaction force on RAD magnetic core 903 in the upward direction. The upward force of the RAD is partially cancelled by the downward pressure force of top cap 902 due to the partial vacuum within the sealed chamber. When sound panel 904 is being pulled inward, which is upward in the orientation of loudspeaker 900 (creating positive air pressure in the sealed chamber that creates an upward force on top cap 902) it creates a reaction force on RAD magnetic core 903 in the downward direction. The downward force of the RAD is partially cancelled by the upward pressure force of top cap 902 due to the positive pressure within the sealed chamber. By utilizing such opposing forces in the loudspeaker, this allows top cap 902 to be made of an inexpensive and lightweight material, such as plastic.

While embodiments of the invention have been shown and described, modifications thereof can be made by one skilled in the art without departing from the spirit and teachings of the invention. The embodiments described and the examples provided herein are exemplary only, and are not intended to be limiting. Many variations and modifications of the invention disclosed herein are possible and are within the scope of the invention. Accordingly, other embodiments are within the scope of the following claims. The scope of protection is not limited by the description set out above, but is only limited by the claims which follow, that scope including all equivalents of the subject matter of the claims.

The disclosures of all patents, patent applications, and publications cited herein are hereby incorporated herein by reference in their entirety, to the extent that they provide exemplary, procedural, or other details supplementary to those set forth herein.

Amounts and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a numerical range of approximately 1 to approximately 4.5 should be interpreted to include not only the explicitly recited limits of 1 to approximately 4.5, but also to include individual numerals such as 2, 3, 4, and sub-ranges such as 1 to 3, 2 to 4, etc. The same principle applies to ranges reciting only one numerical value, such as “less than approximately 4.5,” which should be interpreted to include all of the above-recited values and ranges. Further, such an interpretation should apply regardless of the breadth of the range or the characteristic being described.

Unless defined otherwise, all technical and scientific terms used herein have the same meaning as commonly understood to one of ordinary skill in the art to which the presently disclosed subject matter belongs. Although any methods, devices, and materials similar or equivalent to those described herein can be used in the practice or testing of the presently disclosed subject matter, representative methods, devices, and materials are now described.

Following long-standing patent law convention, the terms “a” and “an” mean “one or more” when used in this application, including the claims.

Unless otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in this specification and attached claims are approximations that can vary depending upon the desired properties sought to be obtained by the presently disclosed subject matter.

As used herein, the term “about” and “substantially” when referring to a value or to an amount of mass, weight, time, volume, concentration or percentage is meant to encompass variations of in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed method.

As used herein, the term “substantially perpendicular” and “substantially parallel” is meant to encompass variations of in some embodiments within ±10° of the perpendicular and parallel directions, respectively, in some embodiments within ±5° of the perpendicular and parallel directions, respectively, in some embodiments within ±1° of the perpendicular and parallel directions, respectively, and in some embodiments within ±0.5° of the perpendicular and parallel directions, respectively.

As used herein, the term “and/or” when used in the context of a listing of entities, refers to the entities being present singly or in combination. Thus, for example, the phrase “A, B, C, and/or D” includes A, B, C, and D individually, but also includes any and all combinations and subcombinations of A, B, C, and D.

1. A loudspeaker comprising:
(a) a sealed enclosure;
(b) a sound panel mechanically connected to the sealed enclosure;
(c) a moveable armature mechanically connected to the sound panel comprising an actuator operable to convert electrical energy into mechanical energy;
(d) a plurality of ferromagnetic elements mechanically connected to the moveable armature; and
(e) a variable volume device placed within the sealed enclosure that is operable to change resonant frequency of the speaker.

2. The loudspeaker of claim 1, wherein the variable volume device is a variable air volume device that is operable to increase or decrease air spring stiffness of the sealed enclosure.

3. The loudspeaker of claim 1, wherein the variable volume device comprises a bellow.

4. The loudspeaker of claim 1, wherein the variable volume device is an electrically operated variable volume device.

5. The loudspeaker of claim 1, wherein the variable volume device is operable to create a temporary positive pressure within the sealed enclosure.

6. The loudspeaker of claim 1, wherein the variable volume device is operable to create a temporary negative pressure within the sealed enclosure.

7. The loudspeaker of claim 1, wherein the variable volume device comprises:
(a) a first valve having an inlet,
(b) a second valve having an outlet,
(c) a pump flowably connected to the first valve and the second valve,
(d) a conduit to outside the sealed enclosure, wherein the conduit is flowably connected to the first and second valve, and
(e) an electronic switch operable to operate the pump, the first valve, and the second valve, wherein
(i) the operation of the pump permits the flow of air through the variable volume device such that
(A) the air flows from the first valve to the pump, and
(B) the air flows from the pump to the second valve,
(ii) the operation of the electronic switch provides for the first valve and the second value to be set in a positive pressure setting in which air pressure is increased in the sealed enclosure, wherein, when the pump is flowing the air,
(A) when the first valve is in the positive pressure setting, the first valve (I) does not permit the flow of air through the inlet, and (II) does permit the flow of air from outside the sealed enclosure, through the conduit, and to the first valve, and
(B) when the second valve is in the positive pressure setting, the first valve (I) does not permit the flow of air between the outside of the sealed enclosure and the second valve through the conduit, and (II) does permit the flow of air from the second valve, through the outlet, and to the sealed enclosure, and
(iii) the operation of the electronic switch provides for the first valve and the second value to be set in a negative pressure setting in which air pressure is decreased in the sealed enclosure, wherein, when the pump is flowing the air,
(A) when the first valve is in the negative pressure setting, the first valve (I) does permit the flow of air from the sealed enclosure, through the inlet, and to the first valve, and (II) does not permit the flow of air between the outside the sealed enclosure and the first valve through the conduit, and
(B) when the second valve is in the negative pressure setting, the first valve (I) does permit the flow of air from the second valve, through the conduit, to the outside of the sealed enclosure, and (II) does not permit the flow of air through the outlet.

8. The loudspeaker of claim 7, wherein the electronic switch is operable to switch the first valve and second valve between the positive pressure settings and the negative pressure settings by reversing polarity of the switch.

9. The loudspeaker of claim 1 further comprising a position sensor operable for sensing the position of the sound panel.

10-12. (canceled)

13. The loudspeaker of claim 1 further comprising an electronic controller.

14. The loudspeaker of claim 1 further comprising a position sensor and an electronic controller.

15. The loudspeaker of claim 1, wherein the variable volume device comprises an electric motor that is operable to change the volume of the variable volume device.

16. The loudspeaker of claim 1 further comprising a position sensor, an electronic controller, and an electric motor that is operable to change the volume of the variable volume device.

17. The loudspeaker of claim 16, wherein the electric motor is powered by the electronic controller in response to the location of the sound panel as measured by the position sensor.

18. The loudspeaker of claim 1, wherein the actuator is a voice coil.

19. The loudspeaker of claim 1, wherein the plurality of ferromagnetic elements are operable for creating a first magnetic force when the sound panel moves away from the sealed enclosure and a second magnetic force with the sound panel moves toward the sealed enclosure.

20. The loudspeaker of claim 19, wherein the first magnetic force and second magnetic force are oppositely directed.

21-27. (canceled)

28. The loudspeaker of claim 1, wherein the variable volume device comprises a linear actuator.

29. The loudspeaker of claim 28, wherein the variable volume device comprises a lead screw.

30. The loudspeaker of claim 1, wherein the variable volume device comprises a linear actuator that can vary the volume of a bellows.

31-32. (canceled)

33. The loudspeaker of claim 13, wherein the electronic controller is operable for analyzing a song file to determine the amplitude, frequency, and prevalence of the musical notes within the song file.

34. The loudspeaker of claim 33, wherein the electronic controller is operable for computing the determined target volume of the variable volume device and for sending a signal to the variable volume device to adjust the volume of the variable volume device so that it is near the determined target volume.

35. The loudspeaker of claim 34, wherein the determined target volume is the volume that minimizes the average power consumption of the actuator.

36. (canceled)

37. The loudspeaker of claim 1 further comprising a pneumatic valve that pneumatically connects the air within the sealed enclosure with the air outside of the sealed enclosure.

38-39. (canceled)

40. The loudspeaker of claim 1, wherein the loudspeaker further comprises a magnetic negative spring (MNS), wherein the MNS comprises:
(a) the plurality of ferromagnetic elements mechanically connected to the moveable armature; and
(b) a stationary core assembly comprising a plurality of stationary ferromagnetic elements.

41. The loudspeaker of claim 40, wherein the MNS is a reluctance assistance driver (RAD).

42-54. (canceled)

55. A loudspeaker comprising:
(a) a sealed enclosure;
(b) a sound panel mechanically connected to the sealed enclosure;
(c) a moveable armature mechanically connected to the sound panel comprising an actuator operable to convert electrical energy into mechanical energy;
(d) a pump-valve operable to change the air pressure within the sealed enclosure to change resonant frequency of the loudspeaker;
(e) a position sensor; and
(f) an electronic controller electrically connected to the position sensor and pump-valve that is operable to move the armature near its centered position.

56. (canceled)

57. A loudspeaker comprising:
(a) a sealed enclosure;
(b) a sound panel mechanically connected to the sealed enclosure;
(c) a moveable armature mechanically connected to the sound panel comprising an actuator operable to convert electrical energy into mechanical energy; and
(d) a magnetic negative spring (MNS) comprising (A) a plurality of ferromagnetic elements mechanically connected to the moveable armature, and (B) a stationary core assembly comprising a plurality of stationary ferromagnetic elements; wherein
(i) the sealed enclosure comprises a sealed enclosure boundary on a side opposite the sound panel; and
(ii) the sealed enclosure boundary is anchored to the stationary core assembly; and
(e) a variable volume device placed within the sealed enclosure that is operable to change resonant frequency of the loudspeaker.

58. (canceled)
